(19) United States
(12) Patent Application Publication
(10) Pub. No.: US 2005/0069656 A1
(43) Pub. Date: Mar. 31, 2005

(54) Thermal transfer recording material

(75) Inventors: Hiroki Nakane, Tokyo (JP); Hiroshi Watanabe, Tokyo (JP); Hiroaki Yamagishi, Tokyo (JP); Hirokazu Koyama, Tokyo (JP)

Correspondence Address: MUSERLIAN, LUCAS AND MERCANTI, LLP, 475 PARK AVENUE SOUTH, 15TH FLOOR, NEW YORK, NY, 10016, US

(73) Assignee: Konica Minolta Photo imaging, Inc., Tokyo (JP)

(21) Appl. No.: 10/941,329

(22) Filed: Sep. 15, 2004

(30) Foreign Application Priority Data
Sep. 25, 2003 (JP) JP2003-332734

(51) Int. Cl. B41M 5/40

(52) U.S. Cl. 428/32.61

(57) ABSTRACT

A thermal transfer recording material containing: (i) a thermal transfer sheet comprising a support having thereon an image transfer layer containing a dye and a first binder resin; and (ii) an image receiving sheet comprising a support having thereon an image receiving layer containing a second binder resin, wherein the dye in the image transfer layer has a melting point (MP₁) of not more than 130° C.

### FIELD OF THE INVENTION

The present invention relates to a novel thermal transfer recording material, and in more detail to a thermal transfer recording material comprised of a thermal transfer sheet and a thermal transfer image receptive sheet according to the heat-sensitive sublimation transfer systems.

### BACKGROUND OF THE INVENTION

Heretofore, as color or black-and-white image forming techniques, known have been those in which images are formed by transferring imagewise thermally diffusible dyes onto an image receptive layer employing thermal printing means such as thermal heads or lasers while facing a thermal transfer sheet comprising the aforesaid thermally diffusible dyes which are subjected to diffusion and migration due to heating with the aforesaid image receptive layer of an image receptive sheet. Such heat-sensitive transfer systems have received an established reputation as a method which enables image formation employing digital data, and also enables formation of high image quality comparable to silver halide photography without using processing solutions, such as a developing solution.

In recent years, for the purpose of enhancing the stability of resulting images, especially improving fixability and lightfastness, heat sensitive transfer materials and image forming methods (post-chelate technology) which employ thermally diffusible chelate forming dyes (hereinafter referred to as post-chelate dyes) are proposed, for example, in Japanese Patent Publication Open to Public Inspection (hereinafter referred to as JP-A) Nos. 59-78893, 59-109349, and 60-2398.

However, along with an increase in printing rate of recent thermal transfer printers, problems occur in which conventional thermal transfer recording materials do not result in sufficient printing density or do not result in desired transferability. Further, heretofore, even though a large amount of dye remains in thermal transfer sheets after printing, thermal transfer sheets, when used once, are disposed, resulting in big disadvantage due to an increase in running cost and hindrance of their spread.

Further, in post-chelate technology, metal ion containing compounds, which are not used in common thermal dye transfer recording systems, are incorporated in the image receptive layer. When an increase in the recording rate is intended, means are occasionally required such as an increase in applied energy or an increase in the added amount of metal ion containing compounds to complete a chelating reaction of the post-chelate dyes with the metal ion containing compounds. Specifically, an increase in the amount of the metal ion containing compounds has resulted in problems in terms of material cost.

For overcoming drawbacks of printing density, a method is disclosed (refer, for example, to Patent Document 1) in which printing density is enhanced by improving the state of dyes in the thermal transfer sheet. However, in this method, no description is made regarding problems caused by residual dyes.

Further, disclosed is a method (refer, for example, to Patent Document 2) to enhance transferability by the presence of a certain type of phthalic acid esters in the dye receptive layer of the thermal transfer image receptive sheet. However, under the present situation such that a further higher rate of printing is forecast, it is difficult to sate that the resulting effects are sufficient.

As noted above, corresponding to an increase in the thermal transfer printing rate and enhancement of required characteristics for media, control on the thermal printer side as well as control of thermal transfer materials comprised of a thermal transfer sheet and a thermal transfer image receptive sheet has been performed. However, the two drawbacks of the printing density and the transferability have not yet been simultaneously solved.

(Patent Document 1)
JP-A No. 2003-220768

(Patent Document 2)
Japanese Patent Publication No. 6-65511

### SUMMARY OF THE INVENTION

In view of the foregoing problems, the present invention was achieved. An object of the present invention is to provide a thermal transfer recording material which results in sufficient printing density, high degree of effective use (transferability) of dyes, and enables production of high quality printed matter, corresponding to an increase in the thermal transfer printing rate and enhancement of required characteristics for media.

An embodiment of the present invention includes a thermal transfer recording material containing:
(i) a thermal transfer sheet comprising a support having thereon an image transfer layer containing a dye and a first binder resin; and
(ii) an image receiving sheet comprising a support having thereon an image receiving layer containing a second binder resin,
wherein the dye in the image transfer layer has a predetermined low melting point (MP₁).

### BRIEF DESCRIPTION OF THE DRAWINGS

FIG. 1 is a sectional view showing one example of the constitution of a thermal transfer sheet and a thermal transfer image receptive sheet constituting the thermal transfer recording material of the present invention.

FIG. 2 is a sectional view showing one example of the embodiment in which one surface of the thermal transfer sheet according to the present invention is successively supplied.

According to the present invention, it is possible to provide thermal transfer recording materials which result in sufficient printing density, high degree of effective use (transferability) of dyes, and enables production of high quality printed matter, corresponding to an increase in the thermal transfer printing rate and enhancement of required characteristics for media.

### DESCRIPTION OF THE PREFERRED EMBODIMENTS

The most preferred embodiments for practice of the present invention will now be described, however, the present invention is not limited thereto.
1. An embodiment of the present invention includes a thermal transfer recording material comprising:
   (i) a thermal transfer sheet comprising a support having thereon an image transfer layer containing a dye and a first binder resin; and
   (ii) an image receiving sheet comprising a support having thereon an image receiving layer containing a second binder resin,
   wherein the dye in the image transfer layer has a melting point (MP₁) of not more than 130° C.
2. Another embodiment of the present invention includes a thermal transfer recording material of Item 1,
   wherein the melting point of the dye (MP₁) is not more than 70° C.
3. Another embodiment of the present invention includes a thermal transfer recording material of Item 1,
   wherein the melting point of the dye (MP₁) and a glass transition point of a main binder resin (Tg₁) in the first binder resin of the image transfer layer satisfy the following relationship:
      Tg₁−MP₁≧0 (° C.)
      provided that the main binder resin is the resin having the largest weight content among the resins contained in the thermal transfer recording material.
4. Another embodiment of the present invention includes a thermal transfer recording material of Item 3,
   wherein the melting point of the dye (MP₁) and the glass transition point of the main binder resin (Tg₁) in the first binder resin satisfy the following relationship:
      Tg₁−MP₁≧15 (° C.)
5. Another embodiment of the present invention includes a thermal transfer recording material of Item 3,
   wherein the melting point of the dye (MP₁) and the glass transition point of the main binder resin (Tg₁) in the first binder resin satisfy the following relationship:
      Tg₁−MP₁≧30 (° C.)
6. Another embodiment of the present invention includes any one of the thermal transfer recording materials of Items 3 to 5,
   wherein the melting point of the dye (MP₁) is not more than 70° C.
7. Another embodiment of the present invention includes any one of the thermal transfer recording materials of Items 3 to 6,
   wherein the dye in the image transfer layer has a heat of fusion of not more than 110 J/g.

8. Another embodiment of the present invention includes any one of the thermal transfer recording materials of Items 3 to 7,
wherein the melting point of the dye (MP₁) and a glass transition point of a main binder resin (Tg₂) in the second binder resin in the image receiving layer of the image receiving sheet satisfy the following relationship:
   −60 (° C.)≦MP₁−Tg₂≦60 (° C.)
9. Another embodiment of the present invention includes any one of the thermal transfer recording material of Items 3 to 7,
   wherein the melting point of the dye (MP₁) and a glass transition point of a main binder resin (Tg₂) in the second binder resin in the image receiving layer of the image receiving sheet satisfy the following relationship:
      −30 (° C.)≦MP₁−Tg₂≦30 (° C.)
10. Another embodiment of the present invention includes any one of the thermal transfer recording materials of Items 1 to 9,
   wherein the image receiving layer of the image receiving sheet contains a compound having a metal ion in the molecule, and the compound is capable of forming a chelated compound with the dye transferred to the image receiving layer from the image transfer layer by heating.
11. Another embodiment of the present invention includes a thermal transfer recording material of Item 10,
   wherein the dye is capable of forming a chelated compound by reacting with the compound containing a metal atom in the molecule.

The inventors of the present invention performed diligent investigation to solve the above-mentioned problems. As a result, it was discovered that by employing a thermal transfer sheet having a dye layer in which the aforesaid dye layer incorporated dyes and binder resins and the melting point (MP₁) of at least one of the aforesaid dyes is at most 130° C. and the difference (Tg₁−MP₁) between the glass transition temperature (Tg₁) and the melting point (MP₁) of the aforesaid dye is at least 0° C. and a thermal transfer recording material having a dye receptive layer, it was possible to realize thermal transfer recording materials which resulted in sufficient printing density, high degree of effective use (transferability) of dyes, and enabled production of high quality printed matter, in response to an increase in the thermal transfer printing rate and enhancement of required characteristics for media, thereby the present invention was achieved.

The present invention will now be detailed.

The thermal transfer recording material of the present invention is comprised of a thermal transfer sheet having a dye layer on at least one side of the substrate sheet and a thermal transfer image receptive sheet having a dye receptive layer on at least one side of the substrate sheet.

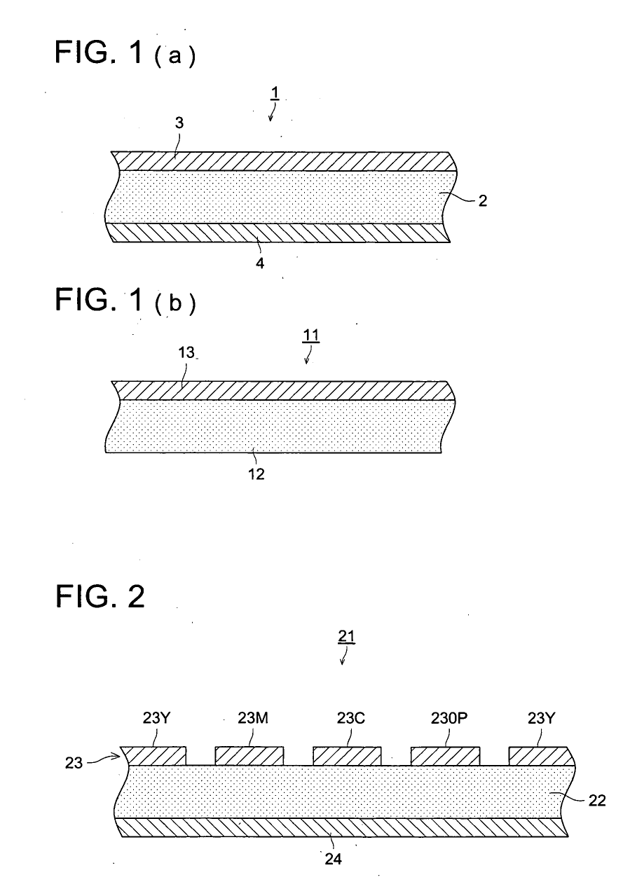

FIG. 1 is a sectional view showing one example of the constitution of a thermal transfer sheet, as well as a thermal transfer image receptive sheet constituting the thermal transfer recording material of the present invention.

FIG. 1(a) is a sectional view showing the representative constitution of the thermal transfer sheet according to the present invention. Thermal transfer sheet 1 comprises dye layer 3 on one side of substrate sheet 2 and a heat resistant slipping layer 4 on the other side of substrate sheet 2. Further, FIG. 1(b) is a sectional view showing the representative constitution of a thermal transfer image receptive layer according to the present invention, and thermal transfer image receptive sheet 11 comprises dye receptive layer 13 on one side of substrate sheet 12.

<<Thermal Transfer Sheet>>

Firstly, the thermal transfer sheet according to the present invention will be described.

(Substrate Sheet)

Employed as substrate sheets employed in the thermal transfer sheet according to the present invention may be any of those known in the art. Listed as specific examples of preferred substrate sheets are thin paper such as glassine paper, condenser paper, or paraffin paper, oriented or non-oriented film composed of plastics such as high heat resistant polyester esters such as polyethylene terephthalate, polyethylene naphthalate, polybutylene terephthalate, polyphenylene sulfide, polyether ketone, or polyether sulfone, polypropylene, fluororesins, polycarbonate, cellulose acetate, polyethylene derivatives, polyvinyl chloride, polyvinylidene chloride, polystyrene, polyamide, polyimide, polymethylpentane, or ionomers, and those prepared by laminating these materials. The thickness of substrate sheets may be determined depending on materials to result in desired strength and heat resistance, but those of a thickness of about 1-100 μm are preferably employed.

Further, in the case in which contact with the dye layer formed on the surface of the substrate sheet is insufficient, it is preferable to apply a primer treatment or a corona treatment on the surface.

(Dye Layer and Dyes)

The dye layer constituting the thermal transfer sheet according to the present invention is a thermally sublimable colorant layer containing at least a dye and a binder resin. Basically employed as dyes used in the thermally sublimable colorant layer may be those of a melting point of a maximum of 130° C. and preferably at most 70° C. Further, the heat of fusion of at least one of the dyes is preferably at a maximum of 110 J/g.

Dyes, employable in the dye layer according to the present invention, may be used individually or in combinations of a plurality of dyes. In the case in which a plurality of dyes is simultaneously used, employed in the dye layer is to be at least one dye which satisfies the aforesaid conditions of the present invention.

By employing such dyes, it is possible to improve the transferability of dyes and to decrease the amount of dyes remaining in the dye layer, whereby it is possible to obtain still higher printing density.

Employable dyes of the present invention will now be described.

Various types of prior art dyes known for thermal transfer recording materials may be employed without any limitation as long as the melting point of dyes is at most 130° C. Of these, preferred are thermally diffusible dyes capable of forming chelates.

Thermal diffusible dyes capable of forming chelates are not particularly limited as long as thermal transfer is possible. Various suitable types of prior art compounds may be selected and subsequently employed. For example, it is possible to use cyan dyes, magenta dyes and yellow dyes, described, for example, in JP-A Nos. 59-78893, 59-109340, and 4-94974, 4-97894, as well as Japanese Patent No. 2856225.

Listed as chelate cyan dyes may be, for example, the compounds represented by General Formula (1) below.

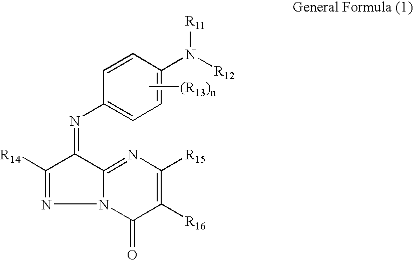

In above General Formula (1), R₁₁ and R₁₂ each represent a substituted or unsubstituted aliphatic group and R₁₁ and R₁₂ may be the same or different. Listed as aliphatic groups are, for example, an alkyl group, a cycloalkyl group, an alkenyl group, and an alkynyl group. Listed as alkyl groups may, for example, be a methyl group, an ethyl group, a propyl group, and an i-propyl group. Listed as groups capable of being substituted to these alkyl groups are a straight or branched alkyl group (e.g., a methyl group, an ethyl group, an i-propyl group, a t-butyl group, an n-dodecyl group, and a 1-hexylnonyl group); a cycloalkyl group (e.g., a cyclopropyl group, a cyclohexyl group, and a bicyclo[2.2.1]heptyl group, and an adamantly group), and an alkenyl group (e.g., a 2-propylene group, and a oleyl group); an aryl group (e.g., a phenyl group, an ortho-tolyl group, an ortho-anisyl group, a 1-naphthyl group, and a 9-anthranyl group); a heterocyclic group (e.g., 2-tetrahydrofuryl group, a 2-thiophenyl group, a 4-imidazolyl group, a 2-pyridyl group); a halogen atom (e.g., a fluorine atom, a chlorine atom, or a bromine atom); a cyano group; a nitro group; a hydroxy group; a carbonyl group (e.g., an alkylcarbonyl group such as an acetyl group, a trifluoroacetyl group, or a pivaloyl group, as well as an aryl carbonyl group such as a benzoyl group, a pentafluorobenzoyl group, or a 3,5-di-t-butyl-4-hydroxybenzoyl group); an oxycarbonyl group (e.g., an alkoxycarbonyl group such as a methoxycarbonyl group, a cyclohexyloxycarbonyl group, an n-dodecyloxycarbonyl group, as well as a heterocyclicoxycarbonyl group such as a phenoxycarbonyl group, a 2,4-di-t-amylphenoxycarbonyl group, or a 1-phenylpyrazolyl-5-oxycarbonyl group); a carbamoyl group (e.g., an alkylcarbamoyl group such as a dimethylcarbamoyl group, a 4-(2,4-di-t-amylphenoxy)butylaminocarbonyl group, as well as an arylcarbamoyl group such as a phenylcarbamoyl group and a 1-naphthylcarbamoyl group); an alkoxy group (e.g., a methoxy group and a 2-ethoxyethoxy group), an aryloxy group (e.g., a phenoxy group, a 2,4-di-t-amylphenoxy group, and a 4-(4-hydroxyphenylsulfonyl)phenoxy group); a heterocyclic oxy group (e.g., a pyridyloxy group and a 2-hexahydropyranyloxy group); a carbonyloxy group (e.g., an acetyloxy group, an alkylcarbonyloxy group such as a trifluoroacetyloxy group or a pivaloyloxy group, an aryloxy group such as a benzoyloxy group, or a pentafluorobenzoyloxy group); a urethane group (e.g., an alkylurethane group such as an N,N-dimethylurethane, and an arylurethane group such as an N-phenylurethane group or a an N-(p-cyanophenyl)urethane group), a sulfonyloxy group (e.g., an alkylsulfonyloxy group such as a methanesulfonyloxy group, a trifluoromethanesulfonyloxy group, or a an n-dodecanesulfonyloxy group, as well as an arylsufonyloxy group such as a benzenesulfonyloxy group or a p-toluenesulfonyloxy group); an amino group (e.g., an alkylamino group such as a dimethylamino group, a cyclohexylamino group, or an n-dodecylamino group as well as an arylamino group such as an anilino group or a p-t-octylanilino group); a sulfonylamino group (e.g., an alkylsulfonylamino group such as a methanesulfonylamino group, a heptafluoropropanesulfonylamino group, or an n-hexadecylsulfonylamino group, as well as an arylsulfonylamino group such as a p-toluenesulfonylamino group or a pentafluorobenzenesulfonylamino group); a sufamoylamino group (e.g., an alkylsulfamoylamino group such as an N,N-dimethylsulfamoylamino group, as well as an arylsulfamoylamino group such as an N-phenylsulfamoylamino group); an acylamino group (e.g., an alkylcarbonylamino group such as an acetylamino group or a myristoylamino group, as well as an arylcarbonylamino group such as a benzoylamino group); a ureido group (e.g., an alkylureido group such as an N,N-dimethylureido group, as well as an arylureido group such as an N-phenylureido group, and an N-(p-cyanophenyl)ureido group); a sulfonyl group (e.g., an alkylsulfonyl group such as a methanesulfonyl group or a trifluoromethanesulfonyl group, as well as an arylsulfonyl group such as a p-toluenesulfonyl group); a sulfamoyl group (e.g., an alkylsulfamoyl group such as a dimethylsulfamoyl group or a 4-(2,4-di-t-amylphenoxy)butylaminosufonyl group, as well as an arylsulfamoyl group such as a phenylsulfamoyl group); an alkylthio group (e.g., a methylthio group and a t-octylthio group); an arylthio group (e.g., a methylthio group and a t-octylthio group); an arylthio group (e.g., a phenylthio group); and a heterocyclic thio group (e.g., a 1-phenyltetrazole-5-thio group and a 5-methyl-1,3,5-oxadiazole-2-thio group).

Examples of the cycloalkyl group and the alkenyl group include those which are the same as the aforesaid substituents. Further, listed as examples of the alkynyl group are 1-propyne, 2-butyne, and 1-hexyne.

Preferred as R₁₁ and R₁₂ are groups which form a non-aromatic ring structure (for example, a pyrrolidine ring, a piperidine ring and a morpholine ring).

Of the above substituents, R₁₃ is preferably an alkyl group, a cycloalkyl group, an alkoxy group, or an acylamino group, while n represents an integer of 0-4. When n is at least 2, a plurality of R₁₃ may be the same or different.

R₁₄ is an alkyl group, examples of which include a methyl group, an ethyl group, an i-propyl group, a t-butyl group, an n-dodecyl group, and a 1-hexylnonyl group. R₁₄ is preferably a secondary or tertiary alkyl group and examples of preferred secondary or tertiary groups include an isopropyl group, a sec-butyl group, a tert-butyl group, and a 3-heptyl group. The most preferred substituents as R₁₄ include an isopropyl group as well as a tert-butyl group. The alkyl group of R₁₄ may be substituted. However, all R₁₄ are substituted with a substituent consisting of carbon atoms and hydrogen atoms are not substituted with a substituent containing other atoms.

R₁₅ is an alkyl group, examples of which include an n-propyl group, an i-propyl group, a t-butyl group, an n-dodecyl group, and a 1-hexylnonyl group. R₁₅ is preferably a secondary or tertary alkyl group, and examples of preferred secondary or tertiary groups include an isopropyl group, a sec-butyl group, a tert-butyl group, and a 3-heptyl group. The most preferred substituents as R₁₅ are an isopropyl group and a tert-butyl group. The alkyl group of R₁₅ may be substituted. However, the aforesaid alkyl group is substituted with a substituent consisting only of carbon atoms and hydrogen atoms, and is not substituted with a substituent containing other atoms.

R₁₆ represents an alkyl group, examples of which include an n-propyl group, an n-butyl group, an n-pentyl group, an n-hexyl group, an n-heptyl group, an isopropyl group, a sec-butyl group, a tert-butyl group, and a 3-heptyl group. Particularly preferred substituents as R₁₆ are straight chain alkyl groups having at least 3 carbon atoms, examples of which include an n-propyl group, an n-butyl group, an n-pentyl group, an n-hexyl group, and an n-heptyl group. The most preferred groups are an n-propyl group and an n-butyl group. Incidentally, the alkyl group represented by R₁₆ may be substituted. However, the aforesaid alkyl group is substituted with a substituent consisting only of carbon atoms and hydrogen atoms, and is never substituted with a substituent containing other atoms.

Further listed as chelate yellow dyes may be the compounds represented by General Formula (2) below.

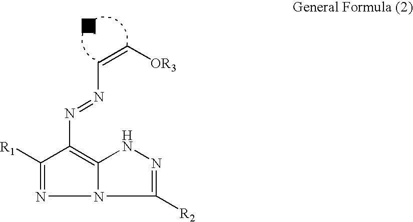

In above General Formula (2), listed as each of the substituents represented by R₁ and R₂ is, for example, a halogen atom, an alkyl group (an alkyl group having 1-12 carbon atoms which may be substituted with a substituent via an oxygen atom, a nitrogen atom, a sulfur atom or a carbonyl group, or may be substituted with an aryl group, an alkenyl group, an alkynyl group, a hydroxyl group, an amino group a nitro group, a carboxyl group, a cyano group, or a halogen atom, such as a methyl, isopropyl, t-butyl, trifluoromethyl, methoxymethyl, 2-methanesulfonylethyl, 2-methanesulfonamidoethyl, or cyclohexyl group), an aryl group (e.g., a phenyl, 4-t-butylphenyl, 3-nitrophenyl, 3-acylphenyl, or 2-methoxyphenyl group), a cyano group, an alkoxy group, an aryloxy group, an acylamino group, an anilino group, a ureido group, a sulfamoylamino group, an alkylthio group, an arylthio group, an alkoxycarbonylamino group, a sulfonamide group, a carbamoyl group, a sulfamoyl group, a sulfonyl group, an alkoxycarbonyl group, a heterocyclic oxy group, an acyloxy group, a carbamoyloxy group, a silyloxy group, an aryloxycarbonylamino group, an imide group, a heterocyclic thio group, a phosphonyl group, and an acyl group.

Listed as alkyl groups and aryl groups represented by R₃ may be those which are the same as the alkyl groups and aryl groups represented by R₁ and R₂.

Specifically listed as 5- to 6-membered aromatic rings which are constituted together with two carbon atoms represented by Z₁ may be rings such as be benzene, pyridine, pyrimidine, triazine, pyrazine, pyridazine, pyrrole, furan, thiophene, pyrazole, imidazole, triazole, oxazole, or thiazole. These rings may form condensed rings together with other aromatic rings. Further, substituents may be positioned on these rings and listed as the above substituents may be those which are the same as ones represented by R₁ and R₂.

Further, listed as chelate magenta dyes may be the compounds represented by General Formula (3) below.

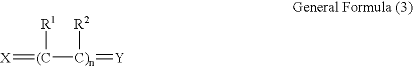

In above General Formula (3), X represents a group or a group of atoms capable of forming a bidentate chelate; Y represents a 5- or 6-membered aromatic hydrocarbon ring or a group of atoms forming a heterocyclic ring; and R₁ and R₂ each represent a hydrogen atom or a univalent substituent. n represents 0, 1, or 2.

The groups represented by General Formula (4) below are particularly preferred as X.

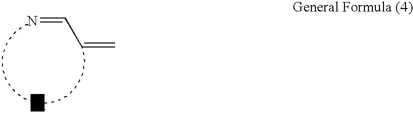

In above General Formula (4), Z₂ represents a group of atoms which is necessary for forming an aromatic nitrogen-containing heterocyclic ring substituted with a group containing at least one nitrogen atom capable of being subjected to chelation. Listed as specific examples of the aforesaid rings are rings such as pyridine, pyrimidine, thiazole, or imidazole. These rings may further form a condensed ring with another carbon ring (such as a benzene ring) or a heterocyclic ring (such as a pyridine ring).

In above General Formula (3), Y represents a group of atoms which forms a 5- or 6-membered aromatic hydrocarbon ring or a heterocyclic ring, and may further have a substituent on the aforesaid ring or a condensed ring. Listed as specific examples of the aforesaid rings are a 3H-pyrrole ring, an oxazole ring, an imidazole ring, a thiazole ring, a 3H-pyrrolizine ring, an oxazolidine ring, an imidazolidine ring, a thiazolidine ring, a 3H-indole ring, a benzoxazole ring, a benzimidazole ring, a benzothiazole ring, a quinoline ring, and a pyridine ring. These rings may further form a condensed ring with another carbon ring (e.g., a benzene ring) and a heterocyclic ring (e.g., a pyridine ring). Substituents on the ring include an alkyl group, an aryl group, a heterocyclic group, an acyl group, an amino group, a nitro group, a cyano group, an acylamino group, an alkoxy group, a hydroxy group, an alkoxycarbonyl group, and a halogen, and these groups may further be substituted.

R₁ and R₂ each represent a hydrogen atom, a halogen atom, (e.g., a fluorine atom, and a chlorine atom), or a univalent substituent. Listed as univalent substituents are, for example, an alkyl group, an alkoxy group, a cyano group, an alkoxycarbonyl group, an aryl group, a heterocyclic group, a carbamoyl group, a hydroxy group, an acyl group, and an acylamino group.

X represents a group or a group of atoms capable of forming at least a bidentate chelate. Any X may be used as long as it is possible to form dyes as General Formula (3). For example, preferred is 5-pyrazolone, imidazole, pyrazole, pyrazolopyrrole, pyrazolopyrazole, pyrazoloimidazole, pyrazolotriazole, pyrazolotetrazole, barbituric acid, thiobarbituric acid, rhodanine, hydantoin, thiohydantoin, oxazolone, isooxazolone, indandione, pyrazolidinedione, oxazolidinedione, hydroxypyridone, or pyrazolopyridone.

(Binder Resins)

The dye layer according to the present invention incorporates binder resins with the above dyes.

Employed as binders used in the dye layer are those which are employed in thermal transfer sheets for conventional heat-sensitive sublimation transfer system. Listed as those binders may, for example, be cellulose based, polyacrylic acid based, polyvinyl alcohol based, and polyvinylpyrrolidone based water-soluble polymers, as well as organic solvent-soluble polymers such as acryl resins, methacryl resins, polystyrene, polycarbonate, polysulfone, polyester sulfone, polyvinyl butyral, polyvinyl acetal, ethylcellulose, and nitrocellulose. Of these, preferred are polyvinyl butyral, polyvinyl acetal, or cellulose based resins.

The content of dyes and binder resins in the dye layer is not particularly limited. It is preferable that in view of performance, the above content is suitably determined.

In the present invention, one of the features is that a binder is used which has a glass transition temperature (Tg₁) which differs in at least 0° C. from the melting point (MP₁) of the above dye.

It is characterized that difference (Tg₁−MP₁) between the glass transition temperature (Tg₁) of the major binder constituting binder resins, and the melting point (MP₁) of the dye is at least 0° C. The above difference is preferably at least 15° C., is more preferably at least 30° C., and is still more preferably 30-200° C.

Values of glass transition temperature of the binder resins according to the present invention are described on pages VI/209-VI/277 in “Polymer Handbook”, Third Edition, John Wily & Sons, 1989, edited by J. Brandrup and E. H. Immergut. Based on these, it is possible to suitably select and employ binder resins having the desired Tg value. Further, it is possible to determine the glass transition temperature of the binder resins according to the present invention utilizing a differential scanning calorimetric method (DSC).

Further, if desired, incorporated in the dye layer according to the present invention may be various prior art additives other than the dyes and binder resins described above. It is possible to form a dye layer in such a manner that a liquid ink coating composition, prepared by dissolving or dispersing the above dyes and binder resins, and other additives in suitable solvents, is applied onto a substrate sheet employing a prior art means, such as a gravure coating method, and subsequently dried. It is possible to set the thickness of the dye layer according to the present invention commonly at about 0.1-about 3.0 μm and preferably at 0.3-1.5 μm.

(Protective Layer)

In the thermal transfer sheet according to the present invention, it is preferable that a thermally transferable protective layer is provided. The above thermally transferable protective layer is composed of a transparent resinous layer which is converted to a protective layer covering, via thermal transfer, the surface of images which are formed on an image receptive layer.

Exemplified as protective layer forming resins may be polyester resins, polystyrene resins, acryl resins, polyurethane resins, acryl urethane resins, polycarbonate resins, epoxy-modified resins of each of these resins, silicone-modified resins of each of these resins, and mixtures thereof, as well as ionizing radiation curing resins and ultraviolet screening resins. Listed as preferred resins are polyester resins, polycarbonate resins, epoxy-modified resins, and ionizing radiation curing resins. Preferred as polyester resins are alicyclic polyester resins comprised of alicyclic compounds comprising at least a diol component and an acid component. Preferred as polycarbonate resins are aromatic polycarbonate resins. Of these, aromatic polycarbonate resins described in JP-A No. 11-151867 are particularly preferred.

Listed as epoxy-modified modified resins employed in the present inventions are epoxy-modified urethane, epoxy-modified polyethylene, epoxy-modified polyethylene terephthalate, epoxy-modified polyphenyl sulfite, epoxy-modified cellulose, epoxy-modified polypropylene, epoxy-modified polyvinyl chloride, epoxy-modified polycarbonate, epoxy-modified acryl, epoxy-modified styrene, epoxy-modified polymethyl methacrylate, epoxy-modified silicone, copolymers of epoxy-modified polystyrene and epoxy-modified polymethyl methacrylate, copolymers of epoxy-modified acryl and epoxy-modified polystyrene, as well as copolymers of epoxy-modified acryl and epoxy-modified silicone. Of these, are preferred epoxy-modified acryl, epoxy-modified polystyrene, epoxy-modified polymethyl methacrylate, and epoxy-modified silicone, but more preferred are copolymers of epoxy-modified polystyrene and epoxy-modified polymethyl methacrylate, copolymers of epoxy-modified acryl and epoxy-modified polystyrene, and copolymers of epoxy-modified acryl and epoxy-modified silicone.

<Ionizing Radiation Curing Resins>

It is possible to use ionizing radiation curing resins as a thermal transferable protective layer. Their incorporation in the thermal transferable protective layer results in excellent plasticizer resistance and abrasion resistance. Employed as ionizing radiation curing resins may be any of those known in the art. For example, if desired employed may be those prepared in such a manner that radically polymerizable polymers or oligomers are subjected to crosslinking and curing by exposure to ionizing radiation and if desired, are subjected to polymerization crosslinking employing electron beams and ultraviolet radiation in the presence of photopolymerization initiators.

<Ultraviolet Screening Resins>

The main purpose of the protective layer containing ultraviolet screening resins is to provide printed matter with lightfastness. As ultraviolet screening resins, it is possible to use, for example, resins which are prepared in such a manner that reactive ultraviolet absorbing agents are allowed to react with, and bond to, thermoplastic resins or the above ionizing radiation curing resins. More specifically, it is possible to list those which are prepared by introducing a reactive group such as ones having an addition-polymerizable double bond (for example, a vinyl group, an acryloyl group, and a metha-acryloyl group) or an alcoholic hydroxyl group, an amino group, a carboxyl group, an epoxy group, or isocyanate group into an unreactive organic ultraviolet absorbing agents such as salicylate based, benzophenone based, benzotriazole based, substituted acrylonitrile based, nickel chelate based, hindered amine based ones which are conventionally known in the art.

The main protective layer arranged in the thermal transferable protective layer, in a singly layer or multilayer structure, as described above, is formed to result in a thickness of commonly about 0.5-about 10 μm, even though it may vary depending on the types of protective layer forming resins.

It is preferable that the thermal transferable protective layer of the present invention is provided on a substrate sheet via a non-transferable releasing layer.

For the purpose such that the non-transferable releasing layer achieves an adhesion force between the substrate sheet and the non-transferable releasing layer which is higher than the adhesion force between the non-transferable releasing layer and the thermally transferable protective lawyer, and also achieves a higher adhesion force between the non-transferable releasing layer and the thermally transferable protective layer after applying heat than that prior to applying heat, it is preferable that (1) minute inorganic particles of an average diameter of at most 40 nm are incorporated in an amount of 30-80 percent by weight together with resinous binders; (2) alkyl vinyl ether-maleic anhydride copolymers or derivatives thereof are incorporated in a total amount of at least 20 percent by weight; or (3) ionomers are incorporated in an amount of at least 20 percent by weight. If desired, other additives may be incorporated in the non-transferable releasing layer.

Employed as inorganic micro-particles may, for example, be silica micro-particles such as colloidal silica, as well as particles of metal oxides such as tin oxide, zinc oxide, or zinc antimonate. It is preferable that the diameter of the inorganic micro-particles is condoled to be at most 40 nm. When the diameter exceeds 40 nm, surface unevenness of the thermally transferable protective layer increases due to the surface unevenness of the releasing layer. As a result, the transparency of the protective layer is unacceptably degraded.

Resinous binders which are blended with inorganic micro-particles are not particularly limited, and it is possible to use any resins which are mixable. Examples include polyvinyl alcohol resins (PVA) of various degrees of saponification, polyvinyl acetal resins, polyvinyl butyral resins, acryl based resins, polyamide based resins, cellulose acetate, alkylcellulose, carboxymethylcellulose, and hydroxyalkylcellulose based resins, as well as polyvinylpyrrolidone resins.

It is preferable that the blending ratio (inorganic micro-particles/other blending components) of the inorganic micro-particles to the other blending components, comprising resinous binders as a main component, is controlled to be in the range of 30/70-80/20 as a weight ratio. When the blending ratio is less than 30/70, desired effects of the inorganic micro-particles become insufficient. On the other hand, when the ratio exceeds 80/20, the resultant releasing layer results in an incomplete layer, whereby portions are formed wherein the substrate sheet and the protective layer are brought into direct contact.

Employed as alkyl vinyl ether-maleic anhydride copolymers or derivatives thereof may, for example, be those in which an alkyl group in the alkyl vinyl ether portion is either a methyl group or an ethyl group, and in which the maleic anhydride portion results in a half ester, partially or completely, with alcohol (e.g., methanol, ethanol, propanol, isopropanol, butanol, and isobutanol).

The releasing layer may be formed by employing only alkyl vinyl ether-maleic anhydride copolymers and derivatives thereof or mixtures thereof. For the purpose of controlling the delamination strength between the releasing layer and the protective layer, other resins or micro-particles may be further added. In such a case, it is preferable that in the releasing layer, alkyl vinyl ether-maleic anhydride copolymers and derivatives thereof, as well as mixtures thereof may be incorporated in an amount of at least 20 percent by weight. When the content is less than 20 percent by weight, it is not possible to result in sufficient desired effects of the alkyl vinyl ether-maleic anhydride copolymers and derivatives thereof.

Resins or micro-particles which are blended with the alkyl vinyl ether-maleic anhydride copolymers or derivatives thereof are not particularly limited, and any of them may be employed as long as they are mixable and result in desired layer transparency during layer formation. For example, preferably are employed resinous binders, which are mixable with the aforesaid inorganic micro-particles, and resinous binders which are mixable with inorganic micro-particles.

Employed as ionomers may, for example, be Surlyn A (manufactured by DuPont Co.) and the Chemipearl Series (manufactured by Mitusi Petrochemicals Co., Ltd.). Further, added to ionomers are, for example, the aforesaid inorganic micro-particles, resinous binders mixable with inorganic micro-particles, or other resins and micro-particles.

The non-transferable releasing layer is formed in such a manner that a liquid coating composition containing any of the aforesaid components (1), (2), and (3) at the specified blending ratio is prepared; the resultant liquid coating composition is applied onto a substrate sheet employing a prior art technique such as a gravure coating method or a gravure reverse coating method; and the resultant coating is dried. The thickness of the non-transferable releasing layer after drying is commonly set at about 0.1-about 2 μm.

A thermally transferable protective layer applied onto a substrate sheet, via or not via the non-transferable releasing layer, may be in a multilayer or a single layer structure. In the case of the multilayer structure, other than the main protective layer which provides various types of durability to images, provided may be an adhesion layer arranged on the outermost surface of the thermally transferable protective layer to enhance adhesion between the thermally transferable protective layer and the image surface of printed matter, an auxiliary protective layer, and a layer (for example, an anti-counterfeiting layer and a hologram layer) which is used to add functions other than original one of the protective layer. The sequence of the main protective layer and other layers are somewhat optional. However, other layers are commonly arranged between the adhesion layer and the main protective layer so that, after the transfer, the main protective layer becomes the outermost surface of the image receiving surface.

An adhesion layer may be formed on the outermost surface of the thermally transferable protective layer. It is possible to form the adhesion layer employing resins such as acryl resins, vinyl chloride based resins, vinyl acetate based resins, vinyl chloride/vinyl acetate copolymer resins, polyester resins, or polyamide resins, which exhibit desired adhesion during an adhesion under heating. Further in addition to the above resins, if desired, ionizing radiation curing resins and ultraviolet screening resins, described above, may be blended. The thickness of the adhesion layer is commonly set at 0.5-5 μm.

The thermally transferable protective layer is formed on a non-transferable releasing layer or a substrate sheet in such a manner that, for example, a liquid protective layer coating composition containing protective layer forming resins, an adhesion layer liquid coating composition containing thermally fusible resins, and if desired, liquid coating compositions, to form additional layers, are previously prepared and those liquid coating compositions are then applied onto the non-transferable releasing layer or the substrate sheet in a predetermined order and subsequently dried. Each of the liquid coating compositions may be applied employing a conventional method known in the art. Further, a primer layer may be arranged between each of the layers.

<UV Absorbers>

It is preferable that UV absorbers are incorporated in at least one of the thermally transferable protective layers. When incorporated in a transparent resinous layer, the resulting transparent ruinous layer is positioned as the surface of printed matter after transferring the protective layer. As a result, effects of UV absorbers decrease due to ambient influence over an extended period of time. Consequently, it is particularly preferable to incorporate UV absorbers in a heat-sensitive adhesive layer.

Listed as UV absorbers are salicylic acid based, benzophenone based, benzotriazole based, and cyanoacrylate based UV absorbers. Specifically, these are commercially available under trade names such as Tinuvin P, Tinuvin 234, Tinuvin 320, Tinuvin 326, Tinuvin 327, Tinuvin 328, Tinuvin 312, and Tinuvin 315 (all manufactured by Ciba-Geigy Corp.); Sumisorb-110, Sumisorb-130, Sumisorb-140, Sumisorb-200, Sumisorb-250, Sumisorb-300, Sumisorb-320, Sumisorb-340, Sumisorb-350, and Sumisorb-400 (all manufactured by Sumitomo Chemical Co., Ltd.); and Mark LA-32, Mark LA-36, and Mark 1413 (all manufactured by Adeka Argus Chemical Co., Ltd.). It is possible to use any of these in the present invention.

Further, it is possible to use random copolymers of a Tg of at least 60° C. and preferably at least 80° C., which are prepared by random polymerization of reactive UV absorbers with acryl based monomers.

Employed as the above reactive UV absorbers may be those prepared by introducing groups having an addition-polymerizable double bond, such as a vinyl group, an acryloyl group, or a methacryloyl group, or other groups such as an alcohol based hydroxyl group, an amino group, a carboxyl group, an epoxy group, or an isocyanate group into prior art non-reactive UV absorbers such as a salicylate based, benzophenone based, benzotriazole based, substituted acrylonitrile based, nickel chelate based UV absorbers, and hindered amine based UV absorbers. Specifically, these are commercially available under the trade names such as UVA635L and UVA633L (all manufactured by BASF Japan Co., Ltd.) and PUVA-30M (manufactured by Otsuka Chemical Co., Ltd.).

The amount of reactive UV absorbers in the above acryl based random copolymers is commonly in the range of 10-90 percent by weight, and is preferably in the range of 30-70 percent by weight. Further, the molecular weight of such random copolymers may be set commonly at about 5,000-about 250,000, and preferably at about 9,000-about 30,000. The aforesaid UV absorbers and random copolymers of reactive UV absorbers with acryl based monomers may be incorporated individually or in combinations of both. The random copolymers of reactive UV absorbers with acyl based monomers are preferably incorporated in an amount ranging from 5 to 50 percent by weight with respect to the incorporated layer.

Of course, other than UV absorbers, other light resistant agents may be incorporated. As used herein, “light resistant agents” refer to chemical agents which minimize modification and decomposition of dyes by absorbing or shielding actions such as radiation energy, heat energy or oxidation which modify or decompose dyes. Other than the aforementioned UV absorbers, examples include antioxidants, conventionally known as additives for synthetic resins, and light stabilizers. When added, these may be incorporated in at least one thermally transferable protective lawyer, namely in at least one of the aforesaid peeling layer, the transparent resinous layer, or the heat-sensitive adhesion layer, and particularly preferably in the heat-sensitive adhesion layer.

Listed as antioxidants are phenol based, monophenol based, bisphenol based or amine based primary antioxidants, as well as sulfur based or phosphorus based secondary antioxidants. Further listed as light stabilizers are hindered amine based ones.

The used amount of the above-mentioned light resistant agents, including UV absorbers, is not particularly limited, and is preferably 0.05-10 parts by weight with respect to 100 parts by weight of resins to form a layer in which the aforesaid agents are incorporated, but more preferably 3-10 parts by weight. When the used amount is excessively small, it is difficult to achieve the desired effects of the light resistant agents, while an excessive amount is not cost effective.

Further, other than the above light resistant agents, it is possible to simultaneously add, to the adhesive layer, various types of additives such as optical brightening agents or fillers in an appropriate amount.

The transparent resinous layer of the protective layer transfer sheet may be arranged individually on a substrate sheet or following the ink layer of a thermal transfer sheet.

(Heat Resistant Slipping Layer)

In the thermal transfer sheet according to the present invention, it is preferable that a heat resistant slipping layer is arranged on the side opposite the dye layer across the substrate sheet.

The aforesaid heat resistant slipping layer is arranged for the purpose of minimizing adhesion of heating devices such as a thermal head with a substrate sheet to achieve smooth production runs and eliminate deposits on thermal heads.

Employed as resins in the aforesaid heat resistant slipping layer are, for example, natural or synthetic resins including cellulose based resins such as ethylcellulose, hydroxycellulose, hydroxypropylcellulose, methylcellulose, cellulose acetate, cellulose acetate butyrate, or nitrocellulose, vinyl based resins such as polyvinyl alcohol, polyvinyl acetate, polyvinyl butyral, polyvinyl acetal, or polyvinylpyrrolidone, acryl based resins such as methyl polymethacrylate, ethyl polymethacrylate, polyacryl amide, acrylonitrile-styrene copolymers, polyimide resins, polyamide resins, polyamidoimide resins, polyvinyl toluene resins, coumarone indene resins, polyester based resins, polyurethane resins, and silicone-modified or fluorine-modified urethane. These may be used individually or in the form of mixtures. In order to enhance heat resistance of the heat resistant slipping layer, it is preferable that of the above resins, resins having a hydroxyl group based reactive group are employed and a crosslinked resinous layer is formed by simultaneously employing polyisocyanate as a crosslinking agent.

Further, in order to provide sliding properties with thermal heads, solid or liquid releasing agents or lubricants may be added to the heat resistant slipping layer to result in heat resistant slipping properties. Employed as releasing agents or slipping agents may, for example, be various waxes such as polyethylene wax or paraffin wax, higher aliphatic alcohol, organopolysiloxane, anionic surface active agents, cationic surface active agents, amphoteric surface active agents, nonionic surface active agents, fluorine based surface active agents, metal soaps, organic carboxylic acids and derivatives thereof, fluororesins, silicone resins, and inorganic micro-particles such as talc or silica. The amount of slipping agents incorporated in the heat resistant slipping layer is commonly 5-50 percent by weight, and is preferably 10-30 percent by weight. It is possible to set the thickness of such a heat resistant slipping layer at about 0.1-10 μm and preferably at 0.3-5 μm.

<<Thermal Transfer Image Receptive Layer>>

The thermal transfer image receptive layer comprised of at least a substrate sheet and a dye receptive layer according to the present invention will now be described.

(Substrate Sheet)

A substrate sheet employed for the thermal transfer image receptive sheet functions to hold a dye receptive layer. In addition, since heat is applied to the sheet during thermal transfer, it is preferable that the sheet exhibits mechanical strength under high heat to prevent handling problems.

Materials for such a substrate are not particularly limited. Listed as such materials are, for example, condenser paper, glassine paper, parchment paper, paper with a high degree of sizing, synthetic paper (either polyolefin based or polystyrene based), woodfree paper, art paper, coated paper, cast coated paper, wallpaper, lining paper, synthetic resin or emulsion impregnated paper, synthetic rubber latex impregnated paper, synthetic resin internally added paper, paper board, cellulose fiber paper, as well as films comprised of polyester, polyacrylate, polycarbonate, polyurethane, polyimide, polyetherimide, cellulose derivatives, polyethylene, ethylene-vinyl acetate copolymers, polypropylene, polystyrene, polyvinyl chloride, polyvinylidene chloride, polyvinyl alcohol, polyvinyl butyral, nylon, polyether ketone, polysulfone, polyethersulfone, tetrafluoroethylene, perfluoroalkyl vinyl ether, polyvinyl fluoride, tetrafluoroethylene-ethylene, tetrafluoroethylene hexafluoropropylene, polychlorofluoroethylene, and polyvinylidene fluoride. Further, it is possible to use white opaque film prepared by castng synthetic resins containing white pigments and fillers and foamed sheets, for which no particular limitation is imposed.

Further, it is possible to use a laminated body composed of the above components in optional combinations. Listed as examples of representative laminated bodies are combinations of cellulose fiber paper and synthetic paper as well as cellulose synthetic paper and plastic film. The thickness of these component sheets is not limited but is commonly about 10-about 300 μm.

In order to achieve a higher printing speed and obtain higher quality resulting in neither uneven density nor white spots, it is preferable that a layer comprising minute voids is provided. Employed as layers provided with minute voids are plastic film and synthetic paper provided with minute voids in the interior. Further, it is possible to form, on various types of component sheets, a layer provided with minute voids, employing various types of coating systems. Preferably employed as plastic film or synthetic paper provided with minute voids are those which are prepared in such a manner that polyolefin, particularly polypropylene as a main component, inorganic pigments and/or polypropylene, and incompatible polymers are blended and these are employed as a void formation initiating agent and the resultant mixture is oriented and casted into film. When polyester is employed as a main component, the resultant cushioning properties as well as heat insulating properties are inferior to ones in which polypropylene is used as a main component, due to the viscoelastic and thermal properties, whereby photographic printing speed is degraded and uneven density tends to result.

When these aspects are taken into account, the elastic modulus of plastic film and synthetic paper is preferably 5×10⁸-1×10¹⁰ Pa at 20° C. Further, these plastic films and synthetic papers are commonly formed through biaxial orientation, and consequently heat results in shrinkage. When these are allowed to stand at 110° C. for 60 seconds, the degree of shrinkage is customarily 0.5-2.5 percent. The above plastic films or synthetic papers may be composed of a single layer or a plurality of layers. When composed of a plurality of layers, all the layers may contain voids or there may be layer(S) containing no voids. If desired, white pigments as a shielding agent may be blended into the above plastic films and synthetic papers. Further, for an increase in whiteness, additives such as optical brightening agents may be incorporated. It is preferable that the thickness of the minute void containing layer is 30-80 μm.

It is also possible to form a void containing layer employing a method in which coating is performed on a substrate. Employed as plastic resins are prior art resins such as polyester, urethane resins, polycarbonate, acryl resins, polyvinyl chloride, or polyvinyl acetate. These may be employed individually or in combinations of a plurality of types.

Further, if desired, for the purpose of minimizing curling, it is possible to provide, on the side opposite the side of a substrate on which an image receptive layer is applied, a layer composed of resins such as polyvinyl alcohol, polyvinylidene chloride, polyethylene, polypropylene, modified polyolefin, polyethylene terephthalate, or polycarbonate and synthetic paper. Employed as lamination methods may be, prior art lamination methods such as dry lamination, non-solvent (hot melt) lamination, or EC lamination. Of these, a dry lamination method as well as a non-solvent lamination method is preferred. Listed as suitable adhesives for the non-solvent lamination method are, for example, Takenate 720L, manufactured by Takeda Chemical Industries, Ltd., while listed as suitable adhesives for the dry lamination are, for example, Takeluck A969/Takenate A-5(3/1), the Polysol PSA SE-1400 and Vinylol PSA AV-620 Series, manufactured by Showa Highpolymer Co., Ltd. The amount of these adhesives used is about 1-about 8 g/m in terms of solids, and is preferably 2-6 g/m².

When a single plastic film sheet and a single synthetic paper sheet, two plastic film sheets or two synthetic paper sheets, described above, and various types of paper sheets with a single plastic film sheet and a single synthetic paper sheet are laminated, it is possible to join them via an adhesive layer.

For the purpose of enhancing the adhesion strength between the above-mentioned substrate sheet and the dye receptive layer, it is preferable to apply various types of primer treatments or a corona discharge treatment.

(Binder Resins)

It is possible to use prior art binder resins in the thermal transfer image receptive layer according to the present invention. Of these, it is preferable to use binders which are readily colored with dyes. Specifically, it is possible to use polyolefin resins such as polypropylene, halogenated resins such as polyvinyl chloride or polyvinylidene chloride, vinyl based resins such as polyvinyl acetate or polyacrylic acid ester, polyester resins such as polyethylene terephthalate or polybutylene terephthalate, polystyrene resins, polyamide resins, phenoxy resins, copolymers of olefin such as ethylene or propylene with other vinyl based monomers, polyurethanes, polycarbonate, acryl resins, ionomers, compounds such as cellulose derivatives or mixtures thereof. Of these, preferred are polyester based resins, vinyl based resins, and cellulose derivatives.

In the thermal transfer recording materials of the present invention, it is preferable to select binder resins employed in the thermal transfer image receptive sheet so that the difference (MP₁−Tg₂) is from −30 to 30 degrees, wherein MP₁ is the melting point of at least one dye incorporated in the thermal transfer sheet previously described, and Tg₂ is the glass transition temperature of the aforesaid binder resin.

(Releasing Agents)

For the purpose of minimizing thermal fusion of the dye receptive layer according to the present invention with a dye layer, it is preferable to add releasing agents to the aforesaid dye receptive layer. Employed as releasing agents may be phosphoric acid ester based plasticizers, fluorine based compounds, and silicone oil (including reactive curing type silicones). Of these, silicone oil is preferred. Employed as silicone oil may be various types of modified silicone. Specific examples include amino-modified silicone, epoxy-modified silicone, alcohol-modified silicone, vinyl-modified silicone, and urethane-modified silicone. These may be blended and then applied, while they may undergo polymerization employing various reactions and then employed. Releasing agents may be employed individually or in combinations of at least two types. Further the added amount of releasing agents is preferably 0.5-30 parts by weight with respect to 100 parts by weight of dye receptive layer forming resins. When the added amount is beyond the aforesaid range, problems occasionally occur in which a thermal transfer sheet fuses with the dye receptive layer of the thermal transfer image receptive sheet or printing photographic speed is lowered. Incidentally, these releasing agents may not be incorporated in the dye image receptive layer, but it may separately form a releasing layer on the dye receptive layer.

(Metal Ion Compounds)

It is preferable to incorporate metal ion containing compounds (hereinafter also referred to as metal sources) in the dye receptive layer according to the present invention.

Listed as metal sources are inorganic and organic salts of metal ions and metal complexes. Of these, preferred are organic acid salts and complexes. Listed as metals are univalent and multivalent metals which belong to Groups I-VIII of the periodic table. Of these, preferred are Al, Co, Cr, Cu, Fe, Mg, Mn, Mo, Ni, Sn, Ti, and Zn, and Ni, Cu, Cr, Co, and Zn are particularly preferred. Listed as specific examples of metal sources are salts of aliphatic compounds such as acetic acid or stearic acid with Ni²⁺, Cu²⁺, Cr²⁺, Co²⁺, or Zn²⁺, or salts of aromatic carboxylic acids such as benzoic acid or salicylic acid.

In the present invention, particlualy preferred as metal sources are the complexes represented by General Formula (I) below, since it is possible to add them to binder resins in the post-heating region without any problem and they are substantially colorless.
[M(Q₁)_{X}(Q₂)_{Y}(Q₃)_{Z}]^{p+}(L⁻)_{P} General Formula (I)

In above General Formula (1), M represents a metal ion, and preferably represents Ni²⁺, Cu²⁺, Cr²⁺, Co²⁺, or Zn²⁺. Q₁, Q₂, and Q₃ each represent a coordination compound capable of forming a coordination bond with a metal ion represented by M, and each may be the same or different among them. It is possible to select such coordination compounds from those, described, for example, in Kireto Kagaku (Chelate Science) (5), published by Nanko Do. L− represents an organic anion group, and specifically, it is possible list tetraphenylboron anions and an alkylbenzenesufonic acid anions. X represents 1, 2, or 3, Y represents 1, 2, or 0, and Z represents 1 or 0, while P represents 1 or 2. Listed as specific examples of such types of metal sources may be compounds exemplified in U.S. Pat. No. 4,987,049 as well as Compounds No. 1-99 exemplified in JP-A No. 10-241410. Particularly preferred compounds are those represented by General Formula (II) below, described in JP-A No. 10-241410.
M²⁺(X₁⁻)₂ General Formula (II)

In above General Formula (II), M²⁺ represents a divalent transition metal ion. Of these, in view of the color of metal ion providing compounds and the color tone of chelated dyes, nickel and zinc are preferred. X₁⁻ represents a coordination compound capable of forming a complex with divalent metal ions. Further, these compounds may have neutral ligands in response to the central atom, and H₂O and NH₃ are listed as representative ligands.

(Interlayer)

Further, in the thermal transfer image receptive layer, an interlayer may be provided between the substrate sheet and the dye receptive layer. As used in the present invention, the term “interlayer” refers to all the layers between the substrate sheet and the dye receptive layer, and may be multilayered. Listed as functions of the interlayer are a solvent resistant function, a barrier function, an adhesion function, a whiteness providing function, a shielding function, and an antistatic function. However, the functions are not limited thereto, and it is possible to employ all appropriate conventional interlayers known in the art.

In order to provide an interlayer with solvent resistance as well as a barrier function, it is preferable to use water-soluble resins. Listed as such water-soluble resins are cellulose based resins such as carboxymethyl cellulose; polysaccharide based resins such as starch; proteins such as casein, gelatin, or agar; vinyl based resins such as polyvinyl alcohol, ethylene-vinyl acetate copolymers, polyvinyl acetate, vinyl chloride-vinyl acetate copolymers, vinyl acetate-(meth)acryl copolymers, (meth)acryl resins, styrene-(meth)acryl copolymers, styrene resins, and polyamide based resins such as melamine resins, urea resins, or benzoguanamine resins, polyester; and polyurethane. Water-soluble resins, as described herein, refer to resins which are completely dissolved (a particle diameter of at most 0.01 μm) in solvents comprised of water as a main component, or result in a state of colloidal dispersion (0.01-0.1 μm) or slurry (at least 1 μm). Of these water-soluble resins, particularly preferred are those which are neither dissolved in nor swelled by alcohols such as methanol, ethanol, or isopropyl alcohol, or general purpose solvents such as hexane, cyclohexane, acetone, methyl ethyl ketone, xylene, ethyl acetate, butyl acetate, or toluene. In this respect, resins are most preferred which are completely dissolved in solvents containing water as a main component.

In order to provide an interlayer performing an adhesion function, urethane resins and polyolefin based resins are commonly employed, though resins may differ depending on the type of substrates and surface treatments. Further, when thermoplastic resins having active hydrogen and curing agents such as isocyanate compounds are simultaneously employed, desired adhesion function is obtained. In order to allow an interlayer to provide have a whiteness function, it is possible to use optical brightening agents. Listed as usable optical brightening agents may be any of the conventional compounds known in the art. Listed as optical whitening agents are stilbene based, distilbene based, benzoxazole based, styryl-oxazole based, pyrene-oxazole based, coumarin based, aminocoumarin based, imidazole based, benzimidazole based, pyrazolone based, and distyryl-biphenyl based optical brightening agents. It is possible to control whiteness based on the type of these optical brightening agents and the added amount thereof. Optical brightening agents may be added employing any of appropriate methods. Namely, listed is a method in which they are dissolved in water and then added, a method in which they are crushed and dispersed employing a ball mill or a colloid mill and then added, a method in which they are dissolved in high boiling point organic solvents, mixed with a hydrophilic colloidal solution and then added in the form of oil-in-water type dispersion, or a method in which thy are impregnated in polymer latex and then added.

Further, in order to minimize a feeling of glare and unevenness of substrates, titanium oxide may be incorporated in the interlayer. In addition, the use of titanium oxide is preferred since it provides a greater degree of freedom for selecting substrates. Titanium oxide includes two types, namely rutile type titanium oxide and anatase type titanium oxide. When whiteness and desired effects of optical brightening agents are considered, anatase type titanium oxide which exhibits absorption of the ultraviolet region at a shorter wavelength side than rutile type titanium oxide is preferred. In the cases when it is difficult to disperse titanium oxide due to the fact that the binder resins of the interlayer are water-based, dispersion may be performed by employing titanium oxide which is subjected to a hydrophilic surface treatment or conventional dispersing agents such as surface active agents or ethylene glycol. The amount of titanium oxide added is preferably 10-400 parts by weight in terms of solids with respect to 100 parts by weight of the resinous solids.

In order to provide an interlayer with an antistatic function, electrically conductive inorganic fillers, electrically conductive organic materials such as polyanilinesulfonic acid, and prior art electrically conductive materials may be selected and then used while matching with the binder resins of the interlayer. The thickness of such an interlayer is preferably set at about 0.1-about 10 μm.

The recording method employing the thermal transfer recording material of the present invention will now be described.

Practical embodiments in the case in which a thermally transferable protective layer or a post-thermal treatment region is provided to the dye layer of a thermal transfer sheet in the surface order are described with reference to drawings. FIG. 2 is a sectional view showing one example of an embodiment in which one surface of the thermal transfer sheet according to the present invention is successively supplied. Thermal transfer sheet 21 in FIG. 2 is provided with dye layers 23Y, 23M, and 23C corresponding to yellow (Y), magenta (M), and cyan (C) dyes on the same plane of a substrate sheet, and a thermally transferable protective layer or post-thermal treatment region 230P in the face sequence.

Incidentally, in FIG. 2, a small spacing is provided between dye layers. However, such spacing may appropriately be provided in response to the control method of the thermal transfer recording apparatus. Further, in order to perform cue-up of each dye layer at a high accuracy, it is preferable to provide a detection mark on a thermal transfer sheet. The methods for providing such a mark are not particularly limited. The thermal transfer sheet is shown above in which each of the dye layers, and the thermally transferable protective layer or the region which performs the post-thermal treatment are provided on the same plane of the substrate sheet. However, needless to say, it is possible to provide each of the dye layers on an individual substrate sheet. Incidentally, in the case in which reactive dyes are employed in each dye layer, dyes incorporated in the dye layer are compounds prior to reaction. As a result, strictly speaking, they may not be designated as Y, M, and C dyes. However, in terms of a layer which finally forms Y, M, and C images, for convenience, they are designated as dye layers.

In the present invention, in chelate type sublimation thermal transfer, chelation is completed after dye transfer. Therefore, it is preferable that a thermal treatment is performed following the dye transfer. During the above post-thermal treatment process, the reaction is completed by heating, employing thermal heads, to result in a uniform heat distribution, and at the same time, it is possible to form images of a desired gloss. Further, the post-thermal treatment and the transfer of the thermally transferable protective layer may simultaneously be carried out. By heating, employing the thermal heads, in the above process to result in a uniform heat distribution, it is possible to form images of a desired gloss.

### EXAMPLES

The present invention is specifically described with reference to examples. However, the present invention is not limited thereto.

<<Preparation of Thermal Transfer Sheet>>

A heat resistant slipping layer liquid coating composition with the composition described below was applied onto the surface opposite the easy adhesion treated surface of a 6 μm thick polyethylene terephthalate film (K-203E-6F, manufactured by Diafoil Hoechst Co., Ltd.) which had been subjected to easy adhesion treatment on one side, employing a gravure coating method and then dried. Thereafter the resultant coating was subjected to a thermal curing treatment, whereby a thermal transfer substrate sheet having a heat resistant slipping layer of a dried layer thickness of 1 μm was prepared.

(Heat Resistant Slipping Layer Liquid Coating Composition)

| | |
|---|---|
| Polyvinyl butyral resin (Eslex | 3.5 weight parts |
| BX-1, manufactured by Sekisui | |
| Chemical Industry Co., Ltd.) | |
| Phosphoric acid ester based surface | 3.0 weight parts |
| active agent (Plysurf A208S, | |
| manufactured by Dai-Ichi Kogyo | |
| Seiyaku Co., Ltd.) | |
| Phosphoric acid ester based surface | 0.3 weight parts |
| active agent (Phosphanol RD720, | |
| manufactured by Toho Chemical | |
| Co., Ltd.) | |
| Polyisocyanate (Barnock D750-45, | 19.0 weight parts |
| manufactured by Dainippon Ink | |
| and Chemicals Industry Co., | |
| Ltd.) | |
| Talc (Y/X = 0.03, manufactured by | 0.2 weight parts |
| Nippon Talc Co.) | |
| Methyl ethyl ketone | 35 weight parts |
| Toluene | 35 weight parts |

(Preparation of Dye Layer Liquid Coating Composition and Coating)

Each of Dye Layer Liquid Coating Compositions 1-7, and 11-15 with the compositions described in Table 1 was applied (resulting in a dried solid weight of 0.7 g/m²) onto the surface opposite the surface of the heat resistant slipping layer on polyethylene terephthalate film to form each of the dye layers, employing a wire bar coating method and subsequently dried at 100° C. for one minute, whereby Thermal Transfer Sheets 1-7, and 11-15 were prepared.

The melting point of each of the dyes employed for preparing above Thermal Transfer Sheets 1-7, and 11-15, and heat of fusion determined by a DSC method (some dyes were determined) are as follows.
Y1: melting point of 93° C.
Y2: melting point of 170° C.
Y3: melting point of 70° C., heat of fusion of 84 J/g
M1: melting point of 110° C., heat of fusion of 99 J/g
M3: melting point of 161° C.
C1: melting point of 111° C., heat of fusion of 69 J/g
C2: melting point of at least 207° C.

Each of the binders and solvents described in Table 1 is detailed below.
KY-24: polyvinyl butyral (KY-24 of a Tg of 103° C., manufactured by Denki Kagaku Kogyo K.K.)
BX-5: polyvinyl acetal (BX-5 of a Tg of 86° C., manufactured by Sekisui Chemical Co., Ltd.)
BH-3: polyvinyl acetal (BH-3 of a Tg of 71° C., manufactured by Sekisui Chemical Co., Ltd.)
SP-2105: urethane-modified silicone resin (Diaroma SP-2105, manufactured by Dainichi Seika Co., Ltd.)

*1: methyl ethyl ketone/toluene=3/2 (as a weight ratio)

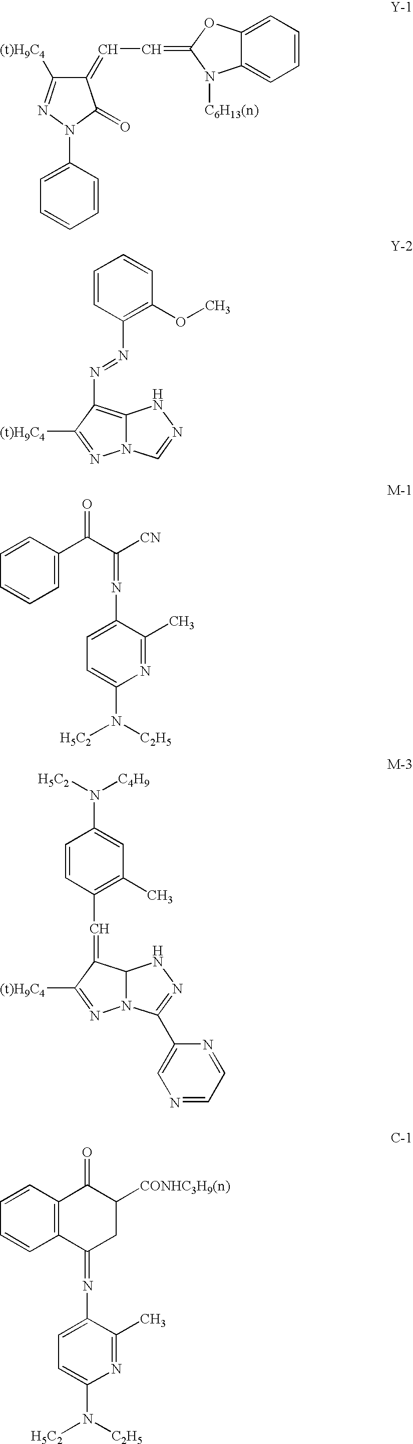

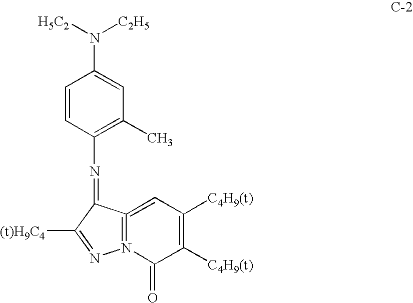

TABLE 1

| | Dye | Dye | | Binder Resin | | | | |
|---|---|---|---|---|---|---|---|---|
| | Layer | | Added | | | | SP- | |
| Thermal | Liquid | | Amount | KY-24 | BX-5 | BH-3 | 2105 | |
| Transfer | Coating | | (in | (in | (in | (in | (in | |
| Sheet | Composition | | weight | weight | weight | weight | weight | |
| No. | No. | Type | parts) | parts) | parts) | parts) | parts) | Solvent *1 |
| 1 | 1 | Y-1 | 5.0 | 5.0 | — | — | 2.0 | 88.0 |
| 2 | 2 | Y-1 | 5.0 | — | 5.0 | — | 2.0 | 88.0 |
| 3 | 3 | Y-1 | 5.0 | — | — | 5.0 | 2.0 | 88.0 |
| 4 | 4 | Y-2 | 5.0 | 5.0 | — | — | 2.0 | 88.0 |
| 5 | 5 | M-1 | 5.0 | 5.0 | — | — | 2.0 | 88.0 |
| 6 | 6 | M-1 | 5.0 | — | 5.0 | — | 2.0 | 88.0 |
| 7 | 7 | M-1 | 5.0 | — | — | 5.0 | 2.0 | 88.0 |
| 11 | 11 | M-3 | 5.0 | 5.0 | — | — | 2.0 | 88.0 |
| 12 | 12 | C-1 | 5.0 | 5.0 | — | — | 2.0 | 88.0 |
| 13 | 13 | C-1 | 5.0 | — | 5.0 | — | 2.0 | 88.0 |
| 14 | 14 | C-1 | 5.0 | — | — | 5.0 | 2.0 | 88.0 |
| 15 | 15 | C-2 | 5.0 | 5.0 | — | — | 2.0 | 88.0 |

<<Preparation of Thermal Transfer Image Receptive Sheet>>

The interlayer liquid coating composition described below was applied onto one surface of 150 μm thick synthetic paper (UPO FPG-150, manufactured by Oji Yuka Goseishi Co., Ltd.), employing a wire bar coating system and subsequently dried at 120° C. for one minute, whereby a sublayer at a dried solid weight of 2.0 g/m² was formed.

Subsequently, each of the dye receptive layer liquid coating compositions with the compositions described in Table 2 was applied onto the aforesaid sublayer to result in a dried solid weight of 4 g/m², employing a wire bar coating system, and subsequently dried at 110° C. for 30 seconds, whereby Thermal Transfer Image Receptive Sheets 1-5 were obtained.

(Interlayer Liquid Coating Composition)

| | |
|---|---|
| 35 percent aqueous acryl based | 5.7 weight parts |
| emulsion (Nikasol A-08, | |
| manufactured by Nippon Carbide | |
| Industries Co., Ltd.) | |
| solution | |
| Pure water | 94.0 weight parts |

Incidentally, each of the additives in the dye receptive layer liquid coating composition described in Table 2 is detailed as follows.
Resin 1: vinyl chloride-vinyl acetate copolymer (vinyl chloride/vinyl acetate=95/5 of a Tg of 78° C.)
Resin 2: vinyl chloride-vinyl acetate copolymer (vinyl chloride/vinyl acetate=76/24 of a Tg of 56° C.)
Resin 3: vinyl chloride-vinyl acetate copolymer (vinyl chloride/vinyl acetate=25/75 of a Tg of 34° C.)
Metal ion containing compound: Ni²⁺[C₇H₁₅COC(COOCH₃)O⁻]₂
Silicone 1: epoxy-modified silicone (X-22-8300T, manufactured by Shin-Etsu Chemical Co., Ltd.)
Silicone 2: epoxy-modified silicone (KF-393, manufactured BY Shin-Etsu Chemical Co., Ltd.)
Silicone 3: amino-modified silicone (KF-343, manufactured by Shin-Etsu Chemical Co., Ltd.)

*2: methyl ethyl ketone=1/1 (in a weight ratio)

TABLE 2

| | Dye | | | | | | | | |
|---|---|---|---|---|---|---|---|---|---|
| | Receptive | | | | | | | | |
| Thermal | Layer | | | | Metal Ion | | | | |
| Transfer | Liquid | Binder Resin | | | Containing | Releasing Agent | | | |
| Image | Coating | Resin 1 | Resin 2 | Resin 3 | Compound | Silicone 1 | Silicone 2 | Silicone 3 | Solvent *2 |
| Receptive | Composition | (weight | (weight | (weight | (weight | (weight | (weight | (weight | (weight |
| Sheet No. | No. | pars) | parts) | parts) | parts) | part) | part) | part) | parts) |
| 1 | 1 | 10.0 | — | — | — | 1.0 | — | — | 40.0 |
| 2 | 2 | — | 10.0 | — | — | 1.0 | — | — | 40.0 |
| 3 | 3 | — | — | 10.0 | — | 1.0 | — | — | 40.0 |
| 4 | 4 | 60.0 | — | — | 40.0 | — | 0.7 | 0.3 | 200.0 |
| 5 | 5 | — | — | 60.0 | 40.0 | — | 0.7 | 0.3 | 200.0 |

<<Image Formation and Evaluation>>
(Image Formation)

The dye receptive layer portion of the thermal transfer image receptive sheet prepared as above and the dye layer of the thermal transfer sheet in combination listed in Table 3 were stacked and set in a thermal transfer apparatus fitted with a 300 dpi (hereinafter dpi represents the number of dots per 2.54 cm) line thermal head in which the resistor shape was rectangular (length in the primary scanning direction of 80 μm×length in the secondary scanning direction of 120 μm). While the thermal head was being brought into pressure contact with the platen roller, dyes were transferred onto the dye receptive layer while heating the reverse side of the ink layer at a conveying rate of 10 millisecond/line and a length per line of 85 μm in such a step pattern that applied energy was successively increased in the range of 5-80 mJ/mm², whereby Images 1-15 and 19-23 were prepared.

(Evaluation of Formed Images)

After performing printing as described above, dye transferability and printing density of thermal transfer image receptive sheets and those printing samples were evaluated based on the methods below.

Transmission density of the thermal transfer sheet after printing, which had been prepared as described above, was determined employing a densitometer (X-rite 310 Status A). Measurements were performed under three conditions of applied energy of 20 mJ/mm², 40 mJ/mm², and 60 mJ/mm². Subsequently, a transfer ratio was calculated based on the formula below, referring to densities prior to and after printing.
Transfer ratio={(transmission density prior to printing−transmission density after printing}/(transmission density prior to printing))×100 (in percent)

Subsequently, the relative transfer ratio of each of Images 1-5 prepared employing Thermal Transfer Sheets 1-3 having Dye (Y-1) was determined utilizing Image 6 (being a comparative example) as a standard; the relative transfer ratio of each of Images 7-15 prepared employing thermal Transfer Sheets 5-7 having Dye (M-1) were determined employing Sample 19 (being a comparative example) as a standard; and the relative transfer ratio of each of Images 20-22 prepared employing Thermal Transfer Sheets 12-14 having Dye (C-1) was determined utilizing Sample 23 (being a comparative example) as a standard. Subsequently, dye transferability was evaluated based on the criteria below.
A: the transfer ratio was at least 110 percent with respect to that of Comparative Example used as a standard
B: the transfer ratio was between 100 and 110 percent with respect to that of Comparative Example used as a standard
C: the transfer ratio was between 90 and 100 percent with respect to that of Comparative Example used as a standard
D: the transfer ratio was less than 90 percent with respect to that of Comparative Example used as a standard
   (Evaluation Method for Printing Density)

The optical reflection density (OD) of each of the printing samples prepared as above was determined employing Macbeth Reflection Densitometer (manufactured by Gretag Macbeth Corp.) and evaluated based on the criteria below.

Evaluation Criteria

For printing samples (Images 1-5) prepared employing Thermal Transfer Sheets 1-3 having Dye (Y-1), Sample 6 (being a comparative example) was utilized as a standard; for printing sample (Images 7-15) prepared employing Thermal Transfer Sheets 5-7 having Dyes (M-1), Sample 19 (being a comparative example) was utilized as a standard; and for printing samples (Images 20-22) prepared employing Thermal Transfer Sheets 12-14 having Dye (C-1), Sample 23 (being a comparative example). Subsequently, each of the resulting image density ratios was evaluated based on the criteria below.
A: when the step of OD≈1.0 was used which was the same as the comparative example used as standard, OD was at least 110 percent
B: when the step of OD≈1.0 was used which was the same as the comparative example used as standard, OD was between 100 and 110 percent
C: when the step of OD≈1.0 was used which was the same as the comparative example used as standard, OD was between 90 and 100 percent
D: when the step of OD≈1.0 was used which was the same as the comparative example used as standard, OD was less than 90 percent

Table 3 shows the results obtained as above.

TABLE 3

| | | Thermal | | | |
|---|---|---|---|---|---|
| Image No. | | Transfer | Individual Evaluation | | |
| Printing | Thermal | Image | Result | | |
| Sample | Transfer | Receptive | Dye | Printing | |
| No. | Sheet No. | Sheet No. | Transferability | Density | Remarks |
| 1 | 1 | 1 | A | A | Inv. |
| 2 | 1 | 3 | A | A | Inv. |
| 3 | 1 | 4 | A | B | Inv. |
| 4 | 2 | 1 | B | B | Inv. |
| 5 | 3 | 1 | B | B | Inv. |
| 6 | 4 | 1 | standard | standard | Comp. |
| 7 | 5 | 1 | A | A | Inv. |
| 8 | 5 | 2 | A | A | Inv. |
| 9 | 5 | 3 | A | B | Inv. |
| 10 | 6 | 4 | A | B | Inv. |
| 11 | 6 | 2 | A | A | Inv. |
| 12 | 6 | 3 | A | B | Inv. |
| 13 | 7 | 1 | A | B | Inv. |
| 14 | 7 | 2 | A | B | Inv. |
| 15 | 7 | 5 | A | B | Inv. |
| 19 | 11 | 1 | standard | standard | Comp. |
| 20 | 12 | 3 | A | B | Inv. |
| 21 | 13 | 2 | A | B | Inv. |
| 22 | 14 | 4 | A | B | Inv. |
| 23 | 15 | 1 | standard | standard | Comp. |

Inv.: Present Invention
Comp.: Comparative Example

As can clearly be seen from the results in Table 3, it was confirmed that images or printing samples which were formed employing dyes having the melting point specified by the present invention, or thermal transfer sheets, in which the difference between the melting point of the dye and Tg of the binder resin satisfied the conditions specified by the present invention, resulted in sufficient printing density and exhibited excellent dye transferability compared to comparative examples.

1. A thermal transfer recording material comprising:
(i) a thermal transfer sheet comprising a support having thereon an image transfer layer containing a dye and a first binder resin; and
(ii) an image receiving sheet comprising a support having thereon an image receiving layer containing a second binder resin,
wherein the dye in the image transfer layer has a melting point (MP₁) of not more than 130° C.

2. The thermal transfer recording material of claim 1,
wherein the melting point of the dye (MP₁) is not more than 70° C.

3. The thermal transfer recording material of claim 1,
wherein the melting point of the dye (MP₁) and a glass transition point of a main binder resin (Tg₁) in the first binder resin of the image transfer layer satisfy the following relationship:
Tg₁−MP₁≧0 (° C.)
provided that the main binder resin is the resin having the largest weight content among the resins contained in the thermal transfer recording material.

4. The thermal transfer recording material of claim 3,
wherein the melting point of the dye (MP₁) and the glass transition point of the main binder resin (Tg₁) in the first binder resin satisfy the following relationship:
Tg₁−MP_{1≧15} (° C.)

5. The thermal transfer recording material of claim 3,
wherein the melting point of the dye (MP₁) and the glass transition point of the main binder resin (Tg₁) in the first binder resin satisfy the following relationship:
Tg₁−MP_{1≧30} (° C.)

6. The thermal transfer recording material of claim 3,
wherein the melting point of the dye (MP₁) is not more than 70° C.

7. The thermal transfer recording material of claim 3,
wherein the dye in the image transfer layer has a heat of fusion of not more than 110 J/g.

8. The thermal transfer recording material of claim 3,
wherein the melting point of the dye (MP₁) and a glass transition point of a main binder resin (Tg₂) in the second binder resin in the image receiving layer of the image receiving sheet satisfy the following relationship:
−60 (° C.)≦MP₁−Tg₂≦60 (° C.)

9. The thermal transfer recording material of claim 3,
wherein the melting point of the dye (MP₁) and a glass transition point of a main binder resin (Tg₂) in the second binder resin in the image receiving layer of the image receiving sheet satisfy the following relationship:
−30 (° C.)≦MP₁−Tg₂≦30 (° C.)

10. The thermal transfer recording material of claim 1,
wherein the image receiving layer of the image receiving sheet contains a compound having a metal ion in the molecule, and the compound is capable of forming a chelated compound with the dye transferred to the image receiving layer from the image transfer layer by heating.

11. The thermal transfer recording material of claim 10,
wherein the dye is capable of forming a chelated compound by reacting with the compound containing a metal atom in the molecule.
